(19) United States
(12) Patent Application Publication
(10) Pub. No.: US 2003/0083417 A1
(43) Pub. Date: May 1, 2003

(54) Movable polymer body, polymer actuator and applications

(76) Inventor: Hiroshi Yui, Tokyo (JP)

Correspondence Address: Duane Morris LLP, 1667 K Street N W, Suite 700, Washington, DC, 20006, US

(21) Appl. No.: 09/984,458

(22) Filed: Oct. 30, 2001

(51) Int. Cl. C08K 3/18

(52) U.S. Cl. 524/431; 524/432

(57) ABSTRACT

The present invention is to provide a movable polymer body and actuator that move upon irradiation from outside with light containing near-infrared rays, and applications thereof, the movable polymer body being formed by the adhearing of the plurality of polymer elements different each other in the temperature-rise characteristics upon irradiation with light containing near-infrared rays.

### BACKGROUND OF THE INVENTION

The present invention relates to a newly conceived movable polymer body, actuator and applications thereof, and more particularly to a movable polymer body and a polymer actuator having functionality applicable to products from all industries including sunshade plates, toys, beam switches, robots as well as electric and electronic appliances, telecommunications devices, automobiles, space- and aircraft, industrial machinery, medical devices, civil work and construction, shop-display-ware, daily necessities, and other applications utilizing the functions thereof.

### DESCRIPTION OF THE RELATED ART

Almost every conventional polymer body has been a static substance that does not make any motion by itself like packing materials or baskets.

Nonetheless, there still exist polymer body that acts as an actuator as exemplified by polymer piezoelectric bodies and polymer gel, however, in order to cause such conventional polymer body as exemplified by polymer piezoelectric bodies or polymer gel to make a large motion, a strong electric energy is required. And it is typical that only a feeble motion can be obtained without electric energy.

### SUMMARY OF THE INVENTION

The object of the present invention is to provide a movable polymer body and a movable polymer actuator capable of generating a large movement only with faint energy through irradiation with light containing near-infrared rays without requiring any strong electric power, and to provide applications thereof.

### BRIEF DESCRIPTION OF THE DRAWINGS

FIG. 1 is a vertical section showing an embodiment of the movable polymer body according to the present invention.

FIGS. 2 (A) and (B) show other embodiment of the movable polymer body according to the present invention, in which (A) is a perspective view thereof and (B) is a section view thereof under irradiation with light taken along line C-C in (A).

FIG. 3 is a perspective view of other embodiment of the movable polymer body according to the present invention.

FIG. 4 is a vertical section showing an embodiment of the movable polymer body according to the present invention as used for a sunshade plate.

FIG. 5 is an illustrative view of the results of an evaluation of the movable polymer body obtained from the example 1.

### DESCRIPTION OF THE INVENTION AND PREFERRED EMBODIMENT

Polymer materials such as plastics and rubbers have lower rigidity and higher flexibility when compared with metals or ceramics. Further, the thermal expansion characteristics of polymer materials largely differ according to the temperature, having a tendency of the thermal expansion coefficient becoming higher as the temperature rises.

The present invention is to provide the movable polymer body which starts to move upon irradiation with light containing near-infrared rays, taking advantage of the aforementioned two features.

More specifically, the present invention is to provide a movable polymer body that moves upon irradiation with light, the body being formed by adhearing of the plurality of polymer elements that are different each other in the temperature-rise characteristics upon irradiation with light containing near-infrared rays.

Preferrablly, the present invention is to provide a movable polymer body having the plurality of polymer elements that comprise a first polymer element which is low in temperature rise upon irradiation with light containing near-infrared rays, and a second polymer element which is high in temperature rise upon irradiation with light containing near-infrared rays.

The lights to be irradiated with are beams containing near-infrared rays having the wavelength of 0.75 μm to 25 μm such as sunlight, incandescent lamps, infrared rays and infrared laser beams, and preferably beams including near-infrared rays having the wavelength of 0.8 μm to 2 μm, as they have stronger energy of heat ray. The use of sunlight can realize a motive method that is completely free from electric energy.

In the present invention, preferable embodiment of the first polymer element are two embodiment. One embodiment is free from absorption materials absorbent of near-infrared rays with the wavelength of 0.8 μm to 2 μm in base polymer, another embodiment is blended with any reflection materials reflective of near-infrared rays with the wavelength of 0.8 μm to 2 μm in base polymer.

The said absorption materials are at least any one of those selected from iron bodys including Fe²⁺, carbon black or cyanine dye.

The said reflection materials are at least any one of oxide powders including titanium oxide or zinc oxide or metal powders (Fe²⁺ is removed) including aluminum, silver or gold

The first polymer element may also contain as ingredients low thermal-expansive materials such as fibrous, plate-form and granular inorganic fillers including glass fiber, talc and calcium carbonate.

The base polymer(A) used in the first polymer element may be represented by universal thermoplastic resins such as polyethylene (inclusive of any of low density, medium density, high density and linear low density polyethylene), copolymer of ethylene and vinyl acetate, copolymer of ethylene and acrylic acid, copolymer of ethylene and acrylate, maleic anhydride graft polyethylene, copolymer of ethylene and vinylsilane, vinylsilane graft polyethylene, copolymer of ethylene and alpha olefin, polypropylene (inclusive of any of isotactic, syndiotactic and atactic), copolymer of propylene and ethylene (inclusive of both bloc and random), copolymer of propylene and alpha olefin (exclusive of ethylene), maleic anhydride graft polypropylene, copolymer of propylene and vinylsilane, vinylsilane graft polypropylene, styrene graft polypropylene, polystyrene (inclusive of any of isotactic, atactic and syndiotactic), high impact polystyrene, copolymer of styrene and alpha olefin, copolymer of acrylonitrile and styrene, ternary polymerization of acrylonitrile, butadiene and styrene, polyvinyl chloride, copolymer of vinyl chloride and acrylic acid, copolymer of vinyl chloride and acrylate, poly(methyl methacrylate), poly(vinyl acetate), poly(vinyl alcohol) and petroleum resin, and polymer alloys or copolymers containing any of the above as a component; biodegradable plastics such as poly(lactic acid), poly(hydroxybutylate) poly(butylene succinate), polyethylene succinate, poly(caprolactone), copolymer of hydroxybutylate and hydroxybalilate, and polymer alloys or copolymers containing any of the above as a component; engineering plastics such as polyamide (including nylon 6, nylon 66, nylon 46, nylon 12), polycarbonate, polyethylene terephthalate, polybutylene terephthalate, polytrimethylene terephthalate, polyphenylene ether, modified polyphenylene ether, polyphenylene sulfide, polyoxymethylene, fluororesin (including polytetrafluoroethylene), polyether ether ketone, polyether sulfone, polyallylate, polyether imide, thermoplastic imide, liquid crystallinity polymer (LCP) such as copolymer of parahydroxybenzoic acid and polyethylene, and polymer alloys or copolymers containing any of the above as a component; thermosetting resins such as phenol resin, urea resin, melamine resin, unsaturated polyester, epoxy resin, silicon resin, urethane resin, alkyd resin, polyimide, and polymer alloys or copolymers containing any of the above as a component; synthetic rubbers or natural rubbers such as styrene-butadiene rubber, butyl rubber, nitrile rubber, chloroprene rubber, urethane rubber, silicone rubber, neoprene rubber, neoprene-butadiene rubber, ethylene-propylene rubber, and polymer alloys or copolymer containing any of the above as a component; thermoplastic rubbers such as styrene-butadiene-thermoplastic rubber and polyester-thermoplastic rubber, and polymer alloys or copolymers containing any of the above as a component.

In the present invention, preferable embodiment of the second is to comprise a polymer material which is blended with absorption materials absorbent of near-infrared rays with the wavelength of 0.8 μm to 2 μm in base polymer.

The said absorption materials are at least any one of those selected from iron bodys including Fe⁷⁺, carbon black or cyanine dye.

The base polymer (B) used in the second polymer element may be selected from the same substances as exemplified as the base polymer (A).

The base polymer (A) used in the first polymer element and the base polymer (B) used in the second polymer element may be either the same or distinct each other.

Both the first polymer element and the second polymer element can be evaluated according to the pattern of temperature rise upon irradiation with sunlight, where it is preferable that for the first polymer element the temperature does not rise by more than 13° C. after irradiation with sunlight, and for the second polymer element the temperature rises by no less than 20° C., when a 20 cm square and 0.4 mm thick specimen sheet is irradiated with sunlight for the time period of 2 minutes outdoors in fine weather at the atmospheric temperature of 25° C.

The movable polymer body according to the present invention is formed by bonding the polymer element comprising the first polymer element of low rise in temperature upon irradiation with light containing near-infrared rays to the polymer element comprising the second polymer element of high rise in temperature upon irradiation with light containing near-infrared rays, and is so arranged as to cause a movement as a result of deformation attributable to the difference in thermal expansion coefficient between the both elements upon irradiation of the said movable polymer body with light containing near-infrared rays.

The shape or pattern of combination of the first polymer element and the second polymer element may assume various forms or methods according to purposes, and the mode of movement depends on the kind and the way of combination of the first polymer element and the second polymer element.

For example, the polymer elements may be formed into a tape form, a sheet form or a film form, and may be laid one on another face to back (in tandem), and bonded, or otherwise, be laid horizontally in parallel, and bonded. Furthermore, they may be formed into a bar form and bonded side by side.

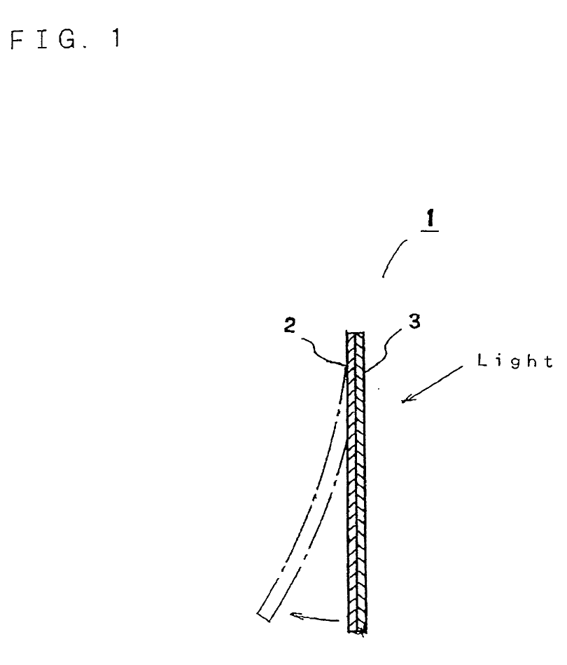

To give a concrete idea, FIG. 1 shows that a movable polymer body 1 in a plate form can be obtained by bonding face to back (in tandem) a film-form polymer element 2 comprising the first polymer, element to a film-form polymer element 3 comprising the second polymer element. In this case, the movable polymer body 1, when irradiated with light containing near-infrared rays, generates a bending movement.

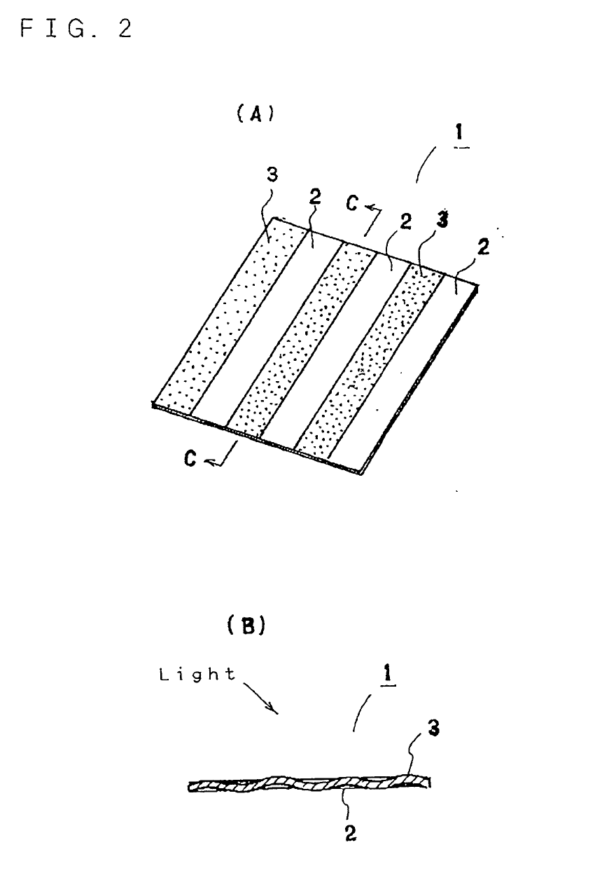

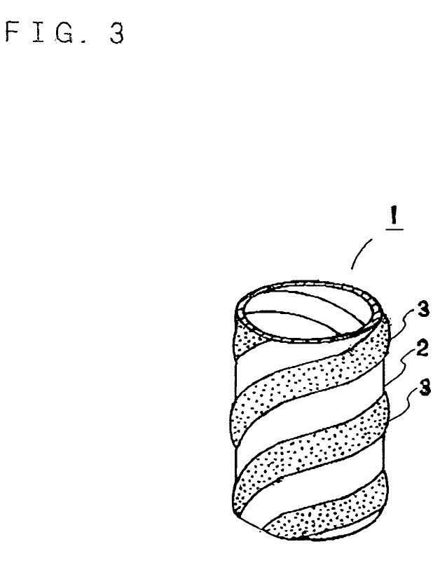

Also, as shown in FIG. 2, another movable polymer body 1 can be obtained by bonding the polymer elements 2 to the polymer elements 3 alternately to form a stripe pattern, and in this case the movable polymer body 1 sprouts small undulations thereon upon irradiation with light containing near-infrared rays. Furthermore, as shown in FIG. 3, a third movable polymer body 1 can also be obtained by bonding the polymer elements 2 to the polymer elements 3 spirally, and it generates spiral undulations on a cylindrical body, when irradiated with light containing near-infrared rays.

In order to bond the polymer elements 2 to the polymer elements 3, any methods including co-extrusion, laminating and gluing can be adopted.

The movable polymer body according to the present invention can be used as a polymer actuator, taking advantage of the aforementioned movement, and further, can actuate a body loaded on or hanged on the said body, control catoptric light and do other things similar thereto.

The movable polymer body according to the present invention can recover its original form from deformation by ceasing the irradiation with the light containing near-infrared rays.

A new motive power system by means of the said body can be established, taking advantage of the aforementioned deformation and movement. For example, a motive power system without using electric energy can be realized, using sunlight, which includes near-infrared rays. Also, a motive power system free from electric wire can be realized, utilizing infrared laser.

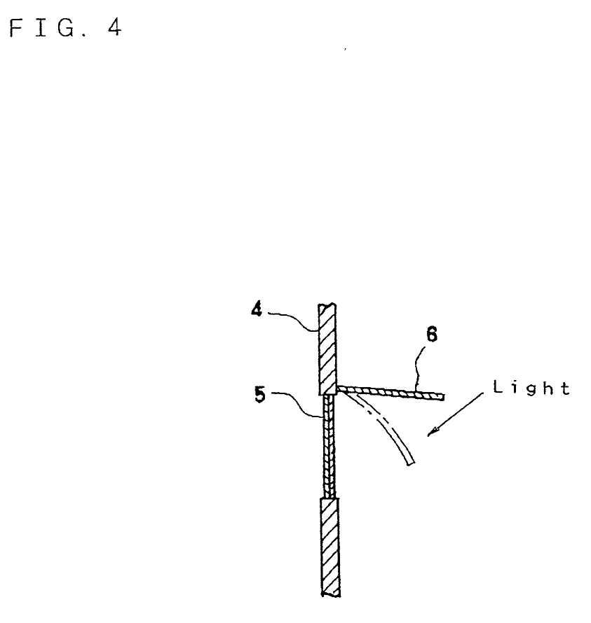

In addition, as shown in FIG. 4, a sunshade 6 that operates upon irradiation with sunlight can be made by mounting the movable polymer body above a window 5 of a building. The said sunshade can be of such construction as to automatically operate to restrict the penetration of sunlight, as the sunlight becomes stronger.

The movable polymer body according to the present invention can be applicable to a variety of products such as toys movable upon irradiation with infrared rays, a beam switch using the characteristics of deformation of the body upon irradiation with infrared laser and a robot moving upon irradiation with infrared laser.

### EXAMPLES

### Example 1

A mixture comprising 95 wt. % in polypropylene and 5 wt. % in titanium oxide, after kneaded in a dual-axial extruder at the temperature of 250° C., and cut into strand cut pellets, was pressed for 10 minutes at the temperature of 230° C. and at the pressure of 100 kg/cm² into a sheet of 20 cm square×0.4 mm thick (sheet A).

Then, a mixture comprising 99 wt. % in polypropylene and 1 wt. % in carbon black, after kneaded in the dual-axial extruder at the temperature of 250° C. and cut into strand cut pellets, was pressed for 10 minutes at the temperature of 230° C. and at the pressure of 100 kg/cm² into a sheet of 20 cm square×0.4 mm thick (sheet B).

The sheet A and the sheet B were respectively irradiated with sunlight outdoors at the temperature of 25° C. in fine weather. The surface temperatures of the sheet A and the sheet B were 32° C. and 53° C. respectively, as measured 2 minutes after the start of irradiation.

A rectangle of 20 cm long and 1 cm wide was cut off from each of the sheet A and the sheet B, and glued each other back to back to form a movable polymer body.

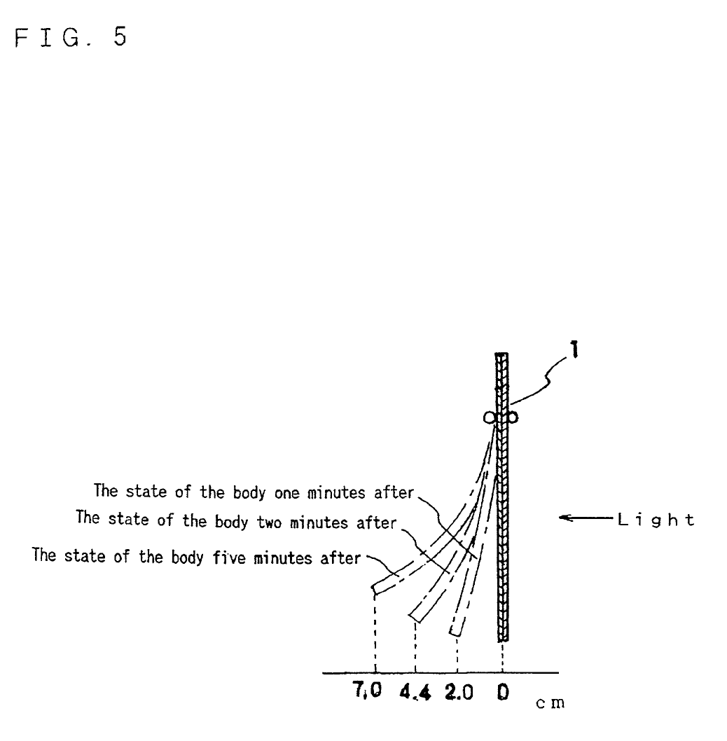

The thus obtained body was hung vertically against the earth outdoors in fine weather at the temperature of 20° C., fixed at the upper part thereof by the length of 6 cm, faced with the sun on the side of the sheet B and irradiated with sunlight. As the irradiation with the sunlight lasted, the said body deformed and moved away in the direction opposite to the sun at the lower part that was free. FIG. 5 shows the states of the body one minute, two minutes and five minutes each after the start of irradiation. Transferred into the shade, the body started again to move to recover the form as it was before the irradiation.

What is claimed is:

1. A movable polymer body that moves upon irradiation with light, the body being formed by adhering of a plurality of polymer elements that are different from each other in the temperature-rise characteristics upon irradiation with light containing near-infrared rays.

2. A movable polymer body according to claim 1, wherein the plurality of polymer elements comprise a first polymer element which is low in temperature rise upon irradiation with light containing near-infrared rays, and a second polymer element which is high in temperature rise upon irradiation with light containing near-infrared rays.

3. A movable polymer body according to claim 2, wherein the first polymer element is free from absorption materials absorbent of near-infrared rays with the wavelength of 0.8 μm to 2 μm.

4. A movable polymer body according to claim 3, wherein the absorption materials are at least any one of those selected from iron bodies including Fe²⁺, carbon black or cyanine dye.

5. A movable polymer body according to claim 2, wherein the first polymer element is blended with any reflection materials reflective of near-infrared rays with the wavelength of 0.8 μm to 2 μm.

6. A movable polymer body according to claim 5, wherein the reflection materials are at least any one of oxide powders including titanium oxide or zinc oxide or metal powders (Fe²⁺ is removed) including aluminum, silver or gold.

7. A movable polymer body according to claim 2, wherein the second polymer material is comprised of a polymer material which is blended with absorption materials absorbent of near-infrared rays with the wavelength of 0.8 μm to 2 μm.

8. A movable polymer body according to claim 7, wherein the absorption materials are at least any one of those selected from iron bodies including Fe²⁺, carbon black cyanine dye.

9. A movable polymer body according to claim 2, wherein the first polymer element and the second polymer element are pasted to each other face to back (in tandem), or alternately to take a form of stripe or spirally.

10. A movable polymer body according to claim 2, wherein the body being usable as a sunshade plate.

11. A polymer actuator using as a motive power source the movable polymer body according to claim 2.

12. A toy enabled to move upon irradiation with infrared rays by means of the polymer actuator according to claim 11 used as an actuator.

13. A beam switch operable upon irradiation with infrared rays by means of the polymer actuator according to claim 11 used as an actuator.

14. A robot operable upon irradiation with infrared rays by means of the polymer actuator according to claim 11 used as an actuator.

15. A movable polymer body according to claim 3, wherein the second polymer material is comprised of a polymer material which is blended with absorption materials absorbent of near-infrared rays with the wavelength of 0.8 μm to 2 μm.

16. A movable polymer body according to claim 15, wherein the body being usable as a sunshade plate.

17. A polymer actuator using as a motive power source the movable polymer body according to claim 15.

18. A toy enabled to move upon irradiation with infrared rays by means of the polymer actuator according to claim 15 used as an actuator.

19. A beam switch operable upon irradiation with infrared rays by means of the polymer actuator according to claim 15 used as an actuator.

20. A robot operable upon irradiation with infrared rays by means of the polymer actuator according to claim 15 used as an actuator.
